(19) United States
(12) Patent Application Publication
(10) Pub. No.: US 2009/0274166 A1
(43) Pub. Date: Nov. 5, 2009

(54) Bandwidth Reservation in a TDMA-based Network

(76) Inventors: Jihui Zhang, Garden Rivera (HK); Zuyuan Fang, Cityone Shatin (HK); Yu Cai, Beijing (CN)

Correspondence Address: WELLS ST. JOHN P.S., 601 W. FIRST AVENUE, SUITE 1300, SPOKANE, WA, 99201, US

(21) Appl. No.: 12/112,396

(22) Filed: Apr. 30, 2008

(51) Int. Cl. H04B 7/212

(52) U.S. Cl. 370/443

(57) ABSTRACT

A method of bandwidth reservation in a TDMA-based network comprising a plurality of media access slots, wherein a plurality of transmitter-receiver pairs in the network may reserve the same media access slot.

### BACKGROUND OF THE INVENTION

1. Field of the Invention

This invention relates to wireless communication in distributed networks, and in particular to bandwidth reservation in TDMA-based networks.

2. Background Information

A distributed, or ad hoc, network is one in which there is no central network controller to manage the activities of the network and each member (i.e. node or device) of the network has equal privileges and rights. Access to the network resources is gained thru negotiation among the members in the network. A Wireless Personal Area Network (WPAN) is an example of a small-scale distributed network that can be used for home entertainment, home office and conference room network applications. In a home entertainment environment, typical network applications include video streaming like watching TV and playing DVDs, playing games, downloading files and browsing websites. In a home office and conference room environment, typical network applications include multimedia presentation and file sharing. Each device in the network shares the network medium, for example radio channel in the case of a wireless network, with other devices and must negotiate for use of network resources, including bandwidth reservation. Several bandwidth reservation schemes have been proposed for ad-hoc networks that use a distributed routing protocol to find routes throughout the network and perform bandwidth reservation along the routes.

WiMedia Ultra-wideband (UWB) is a TDMA-based radio technology used for short-range high-bandwidth communications and is ideally suited to use in WPAN applications. A WiMedia UWB radio platform has been proposed by the WiMedia standard committee by incorporating media access control (MAC) and physical layers (PHY) based on Multi-band Orthogonal Frequency Division Multiplexing (MB-OFDM) technology.

The WiMedia MAC protocol eliminates the need for a network infrastructure by applying same set of MAC functions in all network devices. The MAC uses the concept of a network superframe which is a period 65536 microseconds divided into 256 Media Allocation Slots (MAS) each 256 microseconds long. The superframe is also divided into a beacon period and a data period. All devices in the network identify themselves in the beacon period (BP) and negotiate access to MAS in the data period for data communication with other network devices. The WiMedia MAC protocol uses information elements (IEs), which are contained within the beacon and command frames, to convey certain management and control information in the network.

Access to the superframe data period is via one of two mechanisms called Distributed Reservation Protocol (DRP) or Carrier Sense Multiple Access (CSMA) based Priority Contention Access (PCA). In the current invention we are concerned only with the DRP. The objective of reservation is to make sure no interference is caused to a transmission from transmitter device to receiver device. To avoid interference, in a typical ad hoc network, when data packets are transmitting from transmitter device to receiver device, neighbors of both sender and receiver should keep silent. Therefore, when a MAS is reserved for a link from transmitter device (owner) to receiver device (target), neighbor devices of both transmitter and receiver should mark this MAS as unavailable. DRP IE is used to negotiate and maintain a reservation. It includes the requested MASs, status of the reservation as well as owner and target information. A device that wants to access the medium via DRP may reserve one or more MASs in each superframe through DRP-IEs transmitted within beacon frame during the BP or within command frame. If the DRP request issued by owner device does not conflict with other network devices then target device reply with DRP IE with status set as accept to confirm the request, otherwise, target device replies with DRP IE with status set as non-accept together with DRP Availability IE to reject the request and let owner device adjust its requesting MASs. The device can then begin sending data at least one superframe after successfully making a MAS reservation. Whenever a device overhears MASs through DRP IE that is used for other reservations, it should maintain such information, which is called as DRP availability information.

In a distributed multiple-path routing and bandwidth reservation protocol, multiple candidate paths reserve bandwidth during the negotiations procedure. Each hop of each path must reserve MASs according to the QoS requirement of the traffic. Eventually only one path is selected for packet delivery and so during the negotiation if standard DRP is applied then many more slots are reserved by un-used parallel paths than are actually needed, which occupies more bandwidth than necessary, degrades the performance of the DRP protocol and decreases the success rate of both routing and bandwidth reservation.

The slot reservation problem when applying standard DRP is illustrated by FIG. 1 in which a source device S is to transmit data to a destination device D via the distributed ad hoc network comprising other devices I1, I2, I3, and I4. The data transmission will be multi-hop via at least two other devices in the network. The routing and bandwidth reservation protocol works as follows: source device S broadcasts route request message to the network. After routing request is reached destination device D, D selects several routes as temporal routes to perform bandwidth reservation hop by hop up to S. After bandwidth reservation reaches source device, it chooses only one route as final route. In this figure, assume two temporal routes are found: S-I1-I2-D and S-I4-I3-D. For illustration purposes we assume there are only three MAS available in the data period of the superframe. During path routing and reservation with standard DRP a first hop between device D and device I2 along a first route reserves a first slot 1 in the data period. A first hop along a second route from device D to device I3 reserves a second slot 2 in the data period. A second hop along the second route from device I3 to device I4 reserves a third slot 3 of the data period. After just three hops all available MAS in the superframe data period are reserved and so the routing and reservation fails. The routing and reservation can not continue until more MAS become available.

### SUMMARY OF THE INVENTION

Accordingly, it is an object of the current invention to provide a method of bandwidth reservation that overcomes or at least ameliorates problems with the existing DRP method. It is an alternative object of the invention to provide a reservation method for small-scale distributed networks that offers the art with useful alternative.

In a bandwidth reservation method according to the invention multiple-paths for the same connection, i.e. a connection between the same source and destination of the network can reserve the same slot within the data period of the superframe. Information is associated with each reservation, such that multiple transmitter-receiver pairs in the neighborhood could share the same MASs.

In view of the foregoing, there is disclosed herein a method of bandwidth reservation in a TDMA-based network comprising a plurality of media access slots, wherein a plurality of transmitter-receiver pairs in the network may reserve the same media access slot. The method may be used in WiMedia UWB wireless ad-hoc network and may comprises issuing a reservation request for making a media access slot reservation, the reservation request including both reservation and routing information for determining whether two transmitter-receiver pairs may reserve the same media access slot.

In a particular aspect the method may comprises bandwidth reservation for multi-path routing between a source node and a destination node in a TDMA-based ad-hoc network comprising a plurality of media access slots, including making a first reservation for a media access slot for a first route between a source node and a destination node of a network, and making a second reservation for the media access slot for a second route between the source node and the destination node of the network.

Further aspects of the invention will become apparent from the following description, which is given by way of example only.

### BRIEF DESCRIPTION OF THE DRAWINGS

An exemplary form of the present invention will now be described by way of example only and with reference to the accompanying drawings, in which:

FIG. 1 diagrammatically routing and reservation using known distributed bandwidth reservation method, and

FIG. 2 diagrammatically routing and reservation using a distributed bandwidth reservation method according to the invention.

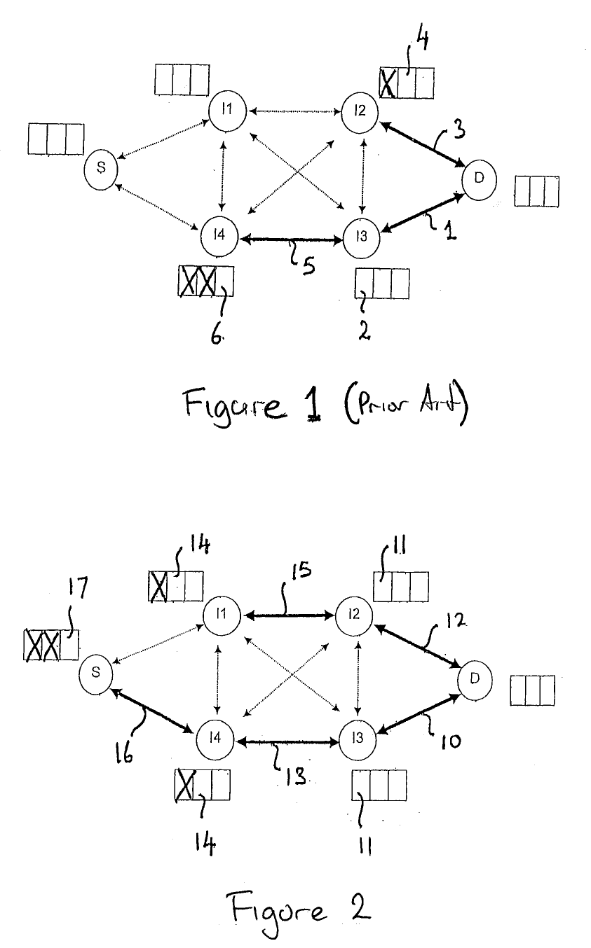

### DESCRIPTION OF THE EXEMPLARY EMBODIMENTS

In a bandwidth reservation method according to the invention multiple-paths for the same connection, i.e. a connection between the same source and destination of the network can reserve the same slot within the data period of the superframe. Information is associated with each reservation, such that multiple transmitter-receiver pairs in the neighborhood could share the same MASs. For example, routing information could be associated with each reservation so that multiple transmitter-receiver pairs on parallel paths for the same connection in the neighborhood can share same MASs: if two reservations belong to the same connection but different paths, then they can share slots; if two reservations belong to the same connection and same path, then they can not share slots. For the simplicity of introducing how to apply the slot sharing distributed bandwidth reservation protocol the invention will be described as implemented in a distributed routing and bandwidth reservation protocol in an ad-hoc network, such as WiMedia MAC. However, this is not intended to limit the scope of use or functionality of the invention and slot sharing distributed bandwidth reservation according to the invention can be implemented in other protocols where distributed network reservation is based on a negotiation procedure.

An illustration of how a method according to the invention works will be described with reference to FIG. 2 in which a source device S is to transmit data to a destination device D via a distributed ad hoc network comprising other devices I1, I2, I3 and I4. The data transmission is multi-hop via at least two other devices in the network. For illustration purposes there are only three MAS available in the data period of the superframe. Assume routing procedure is started from source device S to destination device D while bandwidth reservation procedure is conducted from destination device D back towards source device S. Assume two candidate paths between source S and destinations D are identified: S-I1-I2-D and S-I3-I4-D.

The first reservation request is for a first hop 10 along a first path between device D and device I3 and reserves a first slot 11 of the data period. A second reservation request is then made for a first hop 12 along a second path between the destination device D and the device I2. As this reservation request is identified as being along a different path for the same connection i.e. a connection between the same source S and destination D, then according to a method of the invention it is permitted to reserve the same slot 11 in the data period.

A third reservation request is then made for a second hop 13 along the first path. This request is between devices I3 and I4. As slot 11 is already reserved by hop 10 on the same path, this request reserves the next slot 14 of the data period. The next reservation request in the sequence is a second hop 15 on the second path between devices I2 and I1 of the network. Again, according to the invention because this request is for a different path on the same connection it is also permitted to reserve a slot reserved by a different path, but not the same path. The requested slot is 14 of the superframe date period.

Finally, a third reservation request is made for a third hop 16 along the first path between devices I4 and S of the network. Being a request on the same path in which slot 11 and 14 are already reserved this request must reserve slot 17 of the superframe data period. The reservation is successful and it completes a reservation along the whole connection between the source S and destination D devices of the network using the three available slots of the superframe.

### Example SSDRP Protocol

The following description is an example protocol, hereinafter referred to as Slot Sharing Distributed Reservation Protocol (SSDRP) for implementing this slot-sharing capability among different paths for a multi-path routing and bandwidth reservation protocol according to the invention. This supplements the WiMedia MAC protocol specification, also now ECMA-368 High Rate Ultra Wideband PHY and MAC Standard, which specifies a distributed medium access control (MAC) sublayer and a physical layer (PHY) for wireless UWB networks. The entire contents of ECMA-368 (also approved as ISO/IEC 26907) are hereby incorporated by reference. The example is given by way of example only and is not intended to limit the scope of use or functionality of the invention. The invention is not limited to use with WiMedia MAC and can be implemented in other protocols where distributed network reservation is based on a negotiation procedure.

### 1. Function Description

Incorporated with a distributed multi-path routing protocol, SSDRP can provide slot-sharing capability among different paths for the same connection. To achieve this objective, auxiliary routing information is piggybacked with DRP IE that is used for establishing the standard reservation. Such auxiliary information exists only in the route negotiation procedure. It is removed and only standard DRP IE is left to maintain the reservation after the route is successfully established.

### 1.1 Reservation Type

SSDRP Only Supports hard Type Reservation.

### 1.2 Negotiation

In standard DRP, availability information for a device is obtained by overhearing and is explicitly updated by neighbor devices whenever a reservation between the device and the neighbor fails. In SSDRP, besides overhearing, a device could explicitly requests availability information from target device.

Before invoking a SSDRP request, the reservation owner sends a SSDRP availability request to the reservation target, and the reservation target should reply with bitmap (MAS availability) information corresponding to this request. The SSDRP availability request and response messages include both routing information and reservation information.

A device should reply SSDRP request one by one, and the minimal time between them should be two times mMaxLostBeacons superframes. Whenever a neighboring SSDRP request is overheard, the device should also postpone sending SSDRP request for two times mMaxLostBeacons superframes.

After a SSDRP reply message is received, if the DRP owner finds that there is enough bandwidth available in the target to establish the reservation, the owner issues SSDRP request by sending a pair IE messages to the target, which includes a standard DRP IE and a SSDRP IE to the target. The target then replies with a pair of IE messages to the owner. The formation of DRP IE follows the same procedure as standard DRP. Notice that SSDRP IE can be defined as a new type of IE for WiMedia MAC as used here; it could also be implemented as an ASIE to be compliant with the standard. In addition, a mechanism is required to make sure that such ASIE or SSDRP IE and the corresponding DRP IE can be bounded together and to be sent and received concurrently.

After the route is successfully established, SSDRP IE should be removed while only DRP IE is kept to maintain the reservation along the route.

### 1.3 SSDRP Reservation Availability Information

While negotiating the SSDRP reservation, a local device should differentiate from standard DRP by remembering associated routing related information that is carried by SSDRP IE. For a SSDRP reservation, if a neighboring reservation belongs to a different path for the same connection, it does not cause interference to the reservation.

For multi-path routing and bandwidth reservation protocol, a reservation is conducted from destination device to the source device. SSDRP IE includes connection information as well as path information.

A SSDRP reservation can not use the same MASs for those reservations that belong to different connection and reservations that belong to the same path and same connection. Reservations belong to different connection can be identified by checking associated connection information, for example, source, destination and delivery ID. There are different methods to identify whether reservations belonging to the same path and same connection or not. One can let SSDRP IE records all device EUI address for the path reached so far to identify path. Any other method could be used here for this invention.

### 2. Service Access Points

### 2.1 SSDRP SAP Interface

The SSDRP provides methods for the MAC client to perform slot-sharing capable distributed bandwidth reservation for a multi-path routing protocol. SSDRP reservation negotiations are requested by the MAC client and confirmed by the MAC via the service primitives provided in this subclause. Table 1 summarizes the SSDRP management service primitives.

TABLE 1
SSDRP service primitives

| Service primitive | Request | Indication | Response | Confirm |
|---|---|---|---|---|
| SSDRP- | X | X | X | X |
| RESOURCE | | | | |

Table 2 defines the parameters used by the SSDRP service primitives.

TABLE 2
SSDRP service primitive parameters

| Name | Description |
|---|---|
| Source | Specifies the source of the connection. |
| Destination | Specifies the destination of the |
| | connection. |
| ConnectionID | Identifies the connection to be |
| | etsbliahsed between source and |
| | destination. |
| SrcEUI | Identifies the SSDRP negotiator. |
| DestEUI | Identifies the SSDRP target. |
| MinBW | Minimum required bandwidth for the |
| | connection, in Kbps. |
| DesiredBW | Desired bandwidth for the connection, |
| | in Kbps. Shall not be lower than the |
| | MinBW parameter. |
| AvailableBW | Bandwidth estimated to be available |
| | for the connection, in Kbps. |
| MaxServiceInterval | Maximum service interval acceptable |
| | for the connection, in units of MASs. |
| QoSGoal | The quality of service goal of the |
| | connection to be established. |
| Explicit | Controls whether the SSDRP is |
| | through implicit or explicit. |
| ReservationType | Reservation type. |
| StreamIndex | Identifies a stream from the owner to |
| | the destination. |
| ResultCode | Compeletion status of the MEL |
| | request. |
| ReasonCode | The reason of result for the MEL |
| | request. |
| PathLen | The length of the path in bytes. |
| Path | Identifies a path for a connection. |

1.1.1 SSDRP-RESOURCE.request

This primitive requests the creation of a new SSDRP reservation or release of an existing reservation. The primitive's semantics are as follows:

```
SSDRP-RESOURCE.request (
    DestEUI,
    StreamIndex,
    ReservationType,
    MinBW,
    DesiredBW,
    MaxServiceInterval,
    QoSGoal,
    Explicit,
    Source,
    Destination,
    ConnectionID,
    PathLen,
    Path
  )
```

### 1.1.1.1 When Generated

The MAC client signals this primitive to the MLME in order to create a new SSDRP reservation or release an existing reservation.

### 1.1.1.2 Effect of Receipt

Upon receiving the request, the MLME starts to invoke SSDRP negotiation procedure by forming pair IE message, i.e. DRP IE and SSDRP IE, for a new reservation request or cease on sending pair IE message for releasing an existing reservation. A confirmation will be feedback to DME later on.

1.1.2 SSDRP-RESOURCE.indication

This primitive is used for MLME to indicate that a new connection has been established.

```
SSDRP-RESOURCE.indication(
    SrcEUI,
    StreamIndex,
    Source,
    Destination,
    ConnectionID,
    PathLen,
    Path,
    ResultCode,
    ReasonCode
  )
```

### 1.1.2.1 When Generated

The MLME generates this primitive when it finds the SSDRP reservation is established or detects that a SSDRP reservation is broken.

### 1.1.2.2 Effect of Receipt

The MAC client updates reservation status based on the result.

1.1.3 SSDRP-RESOURCE.response

This primitive is used for MLME to indicate that a new connection has been established.

```
SSDRP-RESOURCE.indication(
    SrcEUI,
    StreamIndex,
    Source,
    Destination,
    ConnectionID,
    PathLen,
    Path,
    ResultCode,
    ReasonCode
  )
```

### 1.1.3.1 When Generated

The MLME generates this primitive when it finds the SSDRP reservation is established or detects that a SSDRP reservation is broken.

### 1.1.3.2 Effect of Receipt

The MAC client updates reservation status based on the result.

1.1.4 SSDRP-RESOURCE.confirm

This primitive is used for MLME to confirm that a new connection has been established.

```
SSDRP-RESOURCE.confirm (
    SrcEUI,
    StreamIndex,
    Source,
    Destination,
    ConnectionID,
    PathLen,
    Path,
    ResultCode,
    ReasonCode
  )
```

### 1.1.4.1 When Generated

The MLME generates this primitive when it finds the SSDRP reservation is successfully established or failure due to some reasons like timeout or lack of bandwidth.

### 1.1.4.1 Effect of Receipt

The MAC client updates reservation status based on the result.

### 3. MAC Frame Formats

### 3.1 Information Elements

TABLE 5
Information elements

| Element ID | Information element | Description |
|---|---|---|
| . | . | . |
| . | . | . |
| . | . | . |
| 28 | SSDRP IE. | To transmit together with |
| | | DRP IE to provide |
| | | slot sharing distributed |
| | | bandwidth reservation. |
| 27-254 | Reserved | Reserved |
| 255 | Application-Specific IE | Use varies depending |
| | (ASIE) | on the application |

### 3.1.1 SSDRP Capability

Slot-sharing DRP capability is announced in MAC capabilities IE, as defined in Table 6, which corresponds to Table 64 in the MAC specification.

TABLE 6
MAC Capabilities Bitmap

| Octet | Bit | Attribute | Description |
|---|---|---|---|
| . | . | | . |
| . | . | | . |
| . | . | | . |
| 1 | . . . | . . . | . . . |
| | 2 | SSDRP | Capable of supporting |
| | | | SSDRP. |
| | 3-7 | Reserved | Reserved |

### 3.1.2 Slot-Sharing Distributed Reservation Protocol IE

The Slot-Sharing Distributed Reservation Protocol (SSDRP) IE is illustrated in Table 7.

TABLE 7
Slot-Sharing Distributed Reservation Protocol IE format

| Octets: 1 | 1 | M |
|---|---|---|
| Element | Length | Content |
| ID | (=1 + M) | |

The detail format of the content filed for SSDRP IE is illustrated in Table 8.

TABLE 8
The format of the content for SSDRP IE

| | Octets: 2 | | | | | | |
|---|---|---|---|---|---|---|---|
| | 2 | 2 | 6 | 6 | 1 | 1 | N |
| DRP | Owner | target | source | destina- | Connec- | PathLen | Path |
| Control | | | | tion | tion | (N) | |
| | | | | | ID | | |

DRP control carries reservation information such as steam index and reservation status. Owner is the MAC address of the reservation owner, Target is the MAC address of the reservation target. Source is the EUI address of the source of the connection, Destination is the EUI address of the destination of the connection, Connection ID is the identification of the connection, PathLen denotes the length of the path identifier in octets, and Path is a string to represent the name of the path.

### 3.1.3 Availability Request and Response Message

A reservation availability request message is used by reservation owner to explicitly request reservation availability information from reservation target, while availability response message is used by reservation target to reply the request. They have similar format, which is shown in Table 9. Where Len denotes the length of the bitmap. If the value of Len is zero, then it is a request message, otherwise, it is a response message. Bitmap denotes MAS availability information, the length is represented by Len.

TABLE 9
the format of the availability request and response message

| | Octets: 1 | | | | | | | | |
|---|---|---|---|---|---|---|---|---|---|
| | 1 | 1 | 6 | 6 | 1 | 1 | N | 1 | N |
| Element | owner | target | source | destination | Connection | PathLen | Path | Len(N) | bitmap |
| ID | | | | | ID | (N) | | | |

What is claimed is:

1. A method of bandwidth reservation in a TDMA-based network comprising a plurality of media access slots, wherein a plurality of transmitter-receiver pairs in the network may reserve the same media access slot.

2. The method of claim 1 wherein the method comprises issuing a reservation request for making a media access slot reservation, the reservation request including both reservation and routing information for determining whether two transmitter-receiver pairs may reserve the same media access slot.

3. The method of claim 2 wherein prior to issuing the reservation request issuing a control message that includes both reservation information and routing information to request reservation availability information from a reservation target.

4. The method of claim 1 when used in WiMedia UWB standard compliant wireless ad-hoc network.

5. A method of bandwidth reservation for two or more routes between a source node and a destination node in a TDMA-based distributed network comprising a plurality of media access slots, wherein a media access slot may be reserved in the two or more routes.

6. The method of claim 1 wherein the method comprises issuing a reservation information element for making a media access slot reservation, the information element including both reservation and route information for determining whether two or more transmitter-receiver pairs may reserve the same media access slot.

7. The method of claim 6 wherein the information element including both reservation and route information is issued only during a route negotiation procedure, and after completion of the route negotiation procedure information elements include only reservation information.

8. The method of claim 6 wherein the route information comprises identifiers of the route and the source node and the destination node.

9. The method of claim 6 wherein the route information comprises identifiers of the route and of the connection between the source node and the destination node.

10. A method of bandwidth reservation for multi-path routing between a source node and a destination node in a TDMA-based ad-hoc network comprising a plurality of media access slots, the method comprises,
making a first reservation for a media access slot for a first route between a source node and a destination node of a network, and
making a second reservation for the media access slot for a second route between the source node and the destination node of the network.

11. The method of claim 10 wherein making the second reservation for the media access slot comprises providing a reservation information element including both reservation and route information for determining whether the reservation is for the second route between the source node and the destination node of the network.
